(19) United States
(12) Patent Application Publication
(10) Pub. No.: US 2018/0281281 A1
(43) Pub. Date: Oct. 4, 2018

(54) 3D pen

(71) Applicant: Fangli XIE, Guangzhou (CN)

(72) Inventor: Fangli XIE, Guangzhou (CN)

(21) Appl. No.: 15/868,990

(22) Filed: Jan. 11, 2018

(30) Foreign Application Priority Data
Apr. 1, 2017 (CN) 201710213202.8

(51) Int. Cl. B29C 64/321; B43K 8/22; B29C 64/255; B29C 64/295; B29C 64/209; B29C 64/393; B33Y 30/00; B33Y 50/02

(52) U.S. Cl. CPC B29C 64/321; B43K 8/22; B29C 64/255; B33Y 50/02; B29C 64/209; B29C 64/393; B33Y 30/00; B29C 64/295

(57) ABSTRACT

A 3D pen, having a shell, a material feeding device, a heating device and a control chip; a material feeding opening is provided on the shell; the material feeding device has a material feeding motor, a motion transmission mechanism and a material feeding mechanism; the material feeding motor is longitudinally disposed along the shell; a single start worm is provided at a rotation axis of the material feeding motor; the single start worm is connected with the motion transmission mechanism; the material feeding mechanism has a material feeding gear and an assistant wheel; the motion transmission mechanism is connected with the material feeding gear; a wire feeding gap is provided between the material feeding gear and the assistant wheel; the heating device has a nozzle and a heating cavity; the material feeding motor and the heating cavity are both electrically connected with the control chip.

### BACKGROUND OF THE INVENTION

The present invention relates to the technical field of 3D pen, and more specifically relates to a 3D pen which has small size and a long service life.

Rapid development of 3D printing has led to broader and broader applications of 3D printing technology in our daily life. 3D pen has therefore become a popular tool for easy construction of a 3D model, to allow users to create their 3D models of their own styles and to foster their imagination of spaces.

Worm gear drive transmits motion and movements between two axes that spatially intersect with each other. An angle of intersection between the two axes is arbitrary, but generally 90 degrees. As said, worm gear drive transmits motion and movements between two axes that intersect. A single start worm refers to a worm that contains a single spiral thereon, in other words, a single rotation of the worm causes the rotation of a worm wheel by a single tooth. A double start worm refers to a worm that contains two spirals thereon, in other words, a single rotation of the worm causes the rotation of the worm wheel by two teeth.

A material feeding device is provided inside the 3D pen. In order to drive the material feeding device to achieve wire feeding from top to down along the pen body, a reducer is provided at a tail part of the 3D pen according to the prior art. The reducer is fixed inside the pen body by for example screws. The reducer directly drives a wire feeding gear connected with its axis, so that an axial direction of the wire feeding gear is perpendicular to a vertical wire feeding direction from top to down along the pen body. As such, vertical wire feeding is achieved. In order to accommodate the laterally mounted reducer, the 3D pen will either become too thick or require a smaller reducer to avoid excessive thickness. A thick 3D pen is not easy to hold and use and has an unpleasing appearance. A 3D pen that requires a smaller reducer will significantly limit the choice of reducers and thus lead to increase in cost and/or insufficient driving power; more importantly, the reducer will increase the weight of the pen and lead to unstable center of gravity; hence, it is difficult to balance the pen during use and therefore mistakes and errors may easily occur during use. Besides, the material feeding device is generally connected with a motion transmission device through a double start worm; however, this kind of transmission is relatively limited and will easily lead to insufficient driving power or require stronger driving power. Further, a motion transmission mechanism and material feeding mechanism of the material feeding device are usually fixed by a fixing panel at one side, thereby causing imbalance during motion transmission that tilts to one side, causing abrasion of the motion transmission mechanism and the material feeding mechanism and thus lowering their service life. Moreover, the 3D pen melts the fed material by heating; therefore, the pen itself has a higher temperature that may damage the components of the pen and reduce its service life if heat is not timely dissipated.

In view of the aforesaid disadvantages, a 3D pen that has smaller size and longer service life is specifically required.

### BRIEF SUMMARY OF THE INVENTION

In view of the aforesaid disadvantages now present in the prior art, the present invention provides a 3D pen that has smaller size and longer service life.

The objects of the present invention are achieved by the present invention as follows:

A 3D pen, comprising a shell, a material feeding device, a heating device and a control chip; a material feeding opening is provided on the shell; the material feeding device comprises a material feeding motor, a motion transmission mechanism and a material feeding mechanism; the material feeding motor is longitudinally disposed along the shell; a single start worm is provided at a rotation axis of the material feeding motor; the single start worm is connected with the motion transmission mechanism; the material feeding mechanism comprises a material feeding gear and an assistant wheel; the motion transmission mechanism is connected with the material feeding gear; a wire feeding gap is provided between the material feeding gear and the assistant wheel; the heating device comprises a nozzle and a heating cavity; the material feeding motor and the heating cavity are both electrically connected with the control chip.

Furthermore, the shell comprises a head cover, a shell body and a tail cover; the head cover has a conical shape which are opened at two ends; a surface of the head cover is provided with rows of arc-shaped heat dissipation holes; the shell body is a hollow cylinder; a mouth of a top part of the shell body is provided with a power supply slot; the 3D pen is supplied with power by connecting the power supply slot with a power supply through a power adapter; a top surface of the tail cover is provided with the material feeding opening; ventilation openings are also provided on the top surface of the tail cover.

Furthermore, the motion transmission mechanism comprises a first reduction gear set, a second reduction gear set, a third reduction gear set, a fourth reduction gear set and a fifth reduction gear set; the single start worm meshes with a larger gear wheel of the first reduction gear set; a smaller gear wheel of the first reduction gear set meshes with a larger gear wheel of the second reduction gear set; a smaller gear wheel of the second reduction gear set meshes with a larger gear wheel of the third reduction gear set; a smaller gear wheel of the third reduction gear set meshes with a larger gear wheel of the fourth reduction gear set; a smaller gear wheel of the fourth reduction gear set meshes with a larger gear wheel of the fifth reduction gear set.

Furthermore, the material feeding device also comprises a fixing mechanism; the fixing mechanism comprises two longitudinally disposed direction fixing panels; the two panels are parallel with each other; fixing holes are provided on the panels for fixing the motion transmission mechanism and the material feeding mechanism.

Furthermore, rotation axes of the first reduction gear set, second reduction gear set, third reduction gear set, fourth reduction gear set and the fifth reduction gear set are positioned between the two panels through the fixing holes, and are rotatable at the fixing holes.

Furthermore, the material feeding gear is fixed to the rotation axis of the fifth reduction gear set through an axial hole; a rotation axis of the assistant wheel is positioned at the panels through the fixing holes, and is rotatable in the fixing holes; the material feeding gear and the assistant wheel are both disposed on an outer side of the panels; the material feeding gear and the assistant wheel are disposed on the same outer side.

Furthermore, the material feeding mechanism also comprises a material guiding tube; the material guiding tube is a hollow cylindrical soft tube; one end of the material guiding tube is positioned below the wire feeding gap, another end of the material guiding tube is positioned above the heating device.

Furthermore, the 3D pen also comprises a heat dissipation device; the heat dissipation device is positioned between the power supply slot and the material feeding motor; the heat dissipation device comprises a heat dissipation motor and a heat dissipation fan mounted on a rotation axis of the heat dissipation motor.

Furthermore, the heating device also comprises a temperature sensor; the temperature sensor is provided on an outer wall of the heating cavity; the temperature sensor and the control chip are electrically connected.

Furthermore, the 3D pen also comprises a control panel; the control panel is provided on an outer surface of the shell; a wire feeding button, a speed adjustment button, a wire withdrawing button and a display are mounted on the control panel; the wire feeding button, the speed adjustment button, the wire withdrawing button and the display are all electrically connected with the control chip.

### BENEFICIAL EFFECT OF THE PRESENT INVENTION

1. The material feeding motor is longitudinally provided along the shell, thereby effectively reducing the space required at the tail with a laterally mounted material feeding motor. Also, the pen can have a smaller size and the center of gravity of the pen is lowered, thus enhancing the balance and stability of the pen.

2. A single start worm is mounted to the rotation axis of the material feeding motor to increase motion transmission ratio, so that more power is provided for material feeding. As such, a smaller material feeding motor can be used, and as a result, the size of the pen can be further reduced. Besides, vibration and therefore noise can be reduced during motion transmission.

3. The fixing mechanism comprises two direction fixing panels longitudinally mounted. Fixing holes are provide on the panels for fixing the motion transmission mechanism and the material feeding mechanism to balance the force borne by two ends of the each of the motion transmission mechanism and the material feeding mechanism, thereby reducing abrasion between the motion transmission mechanism and the material feeding mechanism during use and thus increasing their service life.

4. The heat dissipation device is provided between the power supply slot and the material feeding motor. The heat dissipation device comprises a heat dissipation motor and a heat dissipation fan mounted on a rotation axis of the heat dissipation motor. Hot air from a lower part inside the shell is sucked up and discharged through the ventilation openings to achieve good heat dissipation effect, such that various components will not be over heated and therefore damaged during operation. Accordingly, the service life of the 3D pen is lengthened.

### BRIEF DESCRIPTION OF THE DRAWINGS

FIG. 1 is a structural diagram of the 3D pen according to the present invention.

FIG. 2 shows an internal structure of the 3D pen according to the present invention.

FIG. 3 is a structural diagram of a head cover of the 3D pen according to the present invention.

FIG. 4 is a structural diagram of a tail cover of the 3D pen according to the present invention.

FIG. 5 is a structural diagram showing connection between a motion transmission mechanism and a material feeding mechanism with a fixing mechanism of the 3D pen according to the present invention.

FIG. 6 is a structural diagram of the fixing mechanism of the 3D pen according to the present invention.

FIG. 7 is a structural diagram of the motion transmission mechanism of the 3D pen according to the present invention.

FIG. 8 is a structural diagram of a material feeding mechanism of the 3D pen according to the present invention.

FIG. 9 is a structural diagram of a heat dissipation device of the 3D pen according to the present invention.

FIG. 10 is a block diagram showing electrical connection structure of the 3D pen.

### DETAILED DESCRIPTION OF THE INVENTION

In all figures, the same component is indicated by the same reference number.

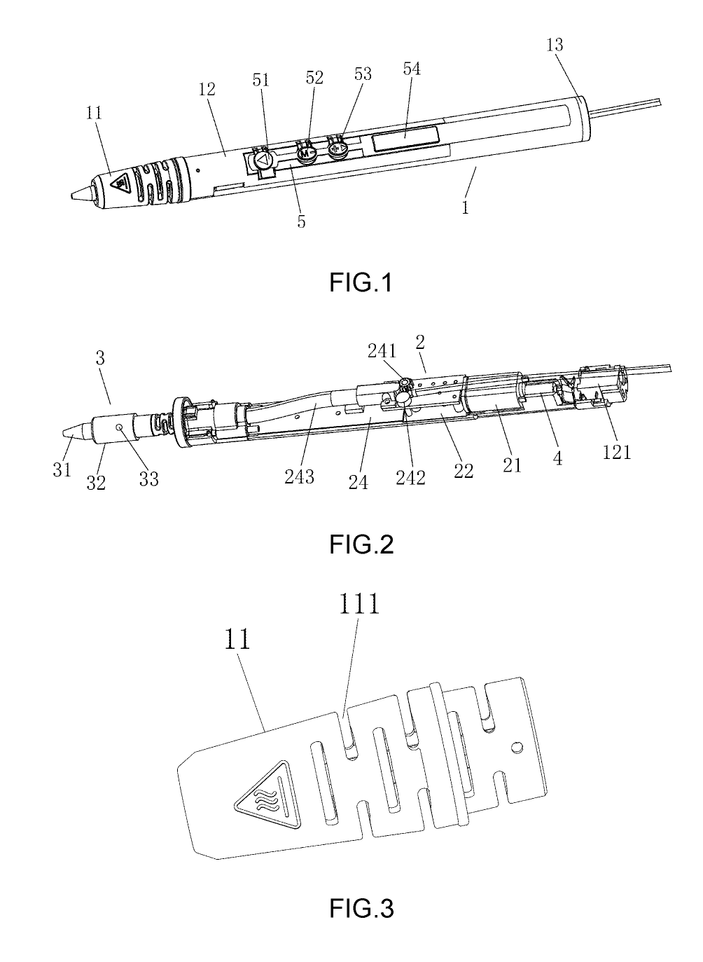

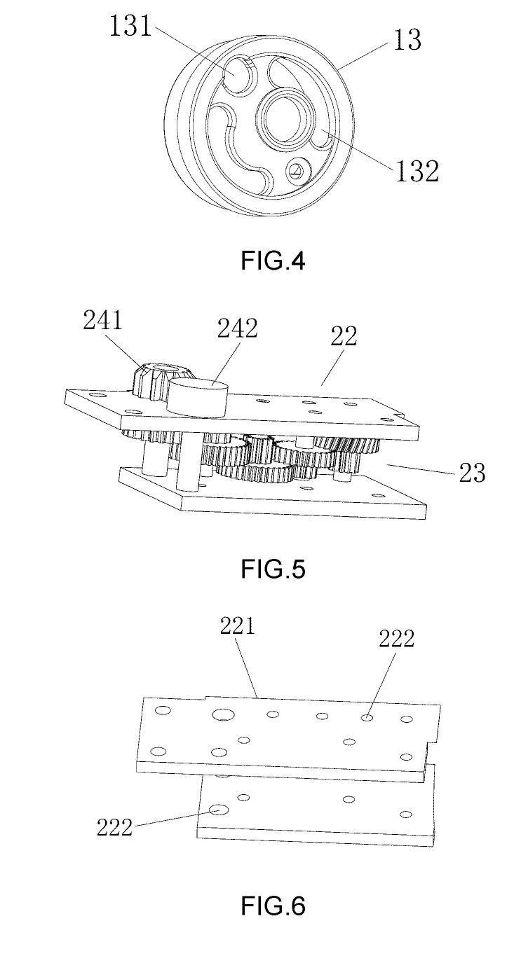

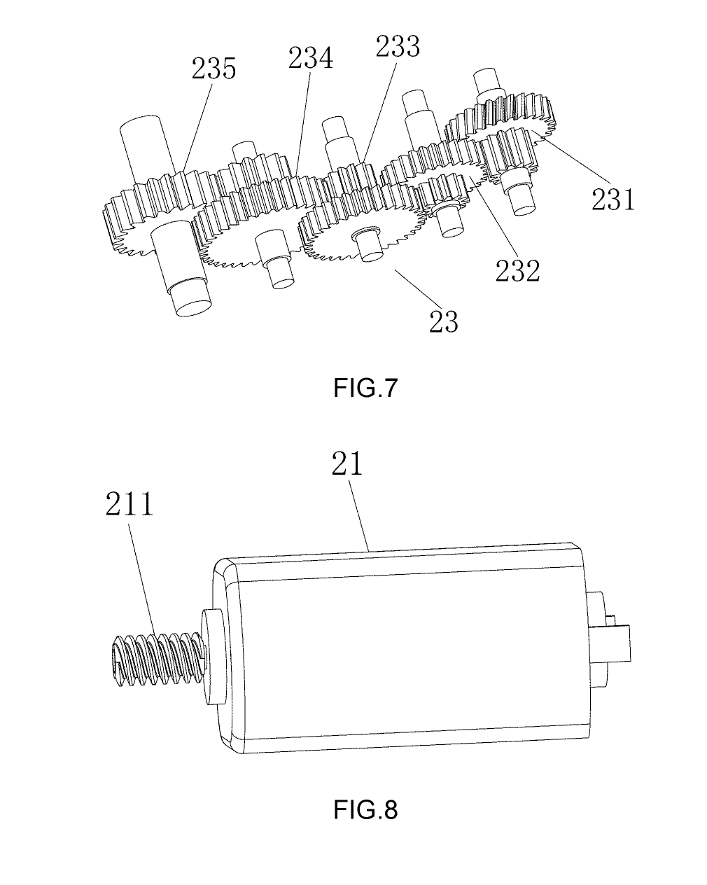

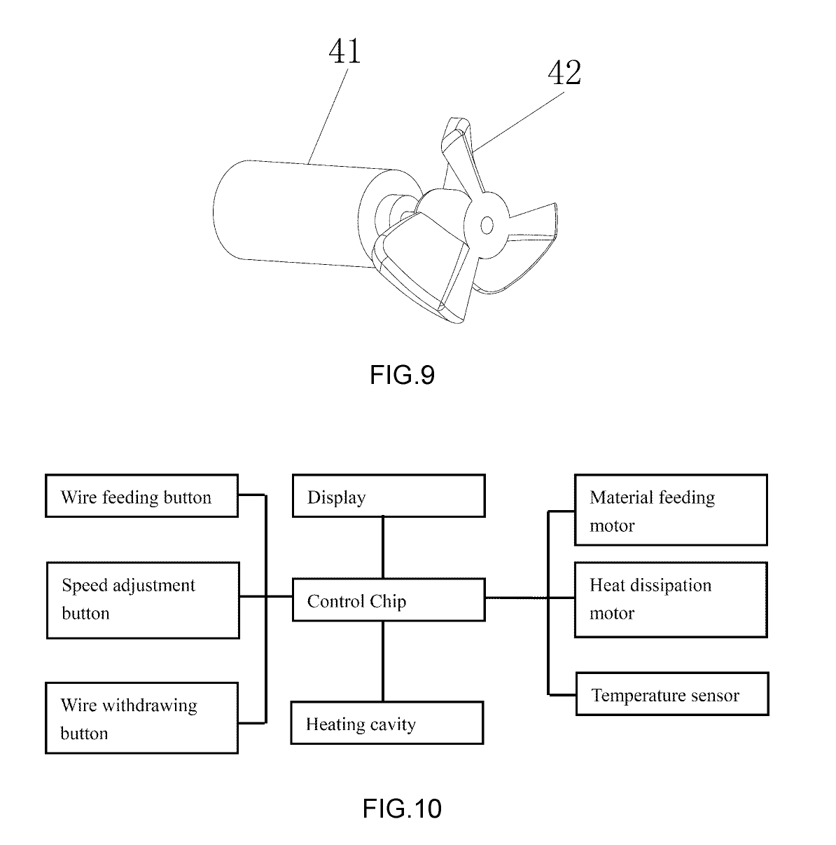

As shown in FIGS. 1-10, a 3D pen according to the present invention comprises a shell 1, a material feeding device 2, a heating device 3, a heat dissipation device 4, a control panel 5 and a control chip.

The shell comprises a head cover 11, a shell body 12 and a tail cover 13. The head cover 11 and the shell body 12 are connected through screw threads or snap-fitting; the shell body 12 and the tail cover 13 are connected through screw threads or snap-fitting; the head cover 11 has a conical shape which are opened at two ends; a surface of the head cover 11 is provided with rows of arc-shaped heat dissipation holes 111; the heat dissipation holes of one row are provided in staggered arrangement with respect to the heat dissipation holes of an adjacent row; the shell body 12 is a hollow cylinder; a mouth of a top part of the shell body 12 is provided with a power supply slot 121; the 3D pen is supplied with power by connecting the power supply slot with a power supply through a power adapter; a top surface of the tail cover 13 is provided with a material feeding opening 131 and ventilation openings 132; each of the ventilation openings 132 has an arc shape; two ventilation openings 132 are provided symmetrically around a central axis of the tail cover 13.

The material feeding device 2 is provided inside the shell body 12; the material feeding device 2 comprises a material feeding motor 21, a fixing mechanism 22, a motion transmission mechanism 23 and a material feeding mechanism 24; the material feeding motor 21 is longitudinally disposed along the shell 1 so as to effectively reduce the space required for the motor 21 which is otherwise laterally mounted at the tail, thereby reducing the size of the 3D pen and lowering its center of gravity which thus enhances the balance and stability of the 3D pen; a single start worm 211 is provided at a rotation axis of the material feeding motor 21 to increase motion transmission ratio and provide more sufficient drive power for wire feeding; also, the material feeding motor 21 being used can be smaller, thereby further reducing the size of the 3D pen as well as the vibration and therefore the noise during motion transmission; the fixing mechanism 22 comprises two longitudinally disposed direction fixing panels 221; the two panels 221 are parallel with each other; fixing holes 222 are provided on the panels 221 for fixing the motion transmission mechanism 23 and the material feeding mechanism 24 to balance the force borne by two ends of the each of the motion transmission mechanism 23 and the material feeding mechanism 24, thereby reducing abrasion between the motion transmission mechanism 23 and the material feeding mechanism 24 during use and thus increasing their service life; the motion transmission mechanism 23 comprises a first reduction gear set 231, a second reduction gear set 232, a third reduction gear set 233, a fourth reduction gear set 234 and a fifth reduction gear set 235; the single start worm 211 meshes with a larger gear wheel of the first reduction gear set 231; a smaller gear wheel of the first reduction gear set 231 meshes with a larger gear wheel of the second reduction gear set 232; a smaller gear wheel of the second reduction gear set 232 meshes with a larger gear wheel of the third reduction gear set 233; a smaller gear wheel of the third reduction gear set 233 meshes with a larger gear wheel of the fourth reduction gear set 234; a smaller gear wheel of the fourth reduction gear set 234 meshes with a larger gear wheel of the fifth reduction gear set 235; rotation axes of the first reduction gear set 231, second reduction gear set 232, third reduction gear set 233, fourth reduction gear set 234 and the fifth reduction gear set 235 are positioned between the two panels 221 through the fixing holes 222, and are rotatable at the fixing holes 222; the material feeding mechanism 24 comprises a material feeding gear 241, an assistant wheel 242 and a material guiding tube 243; the material feeding gear 241 is fixed to the rotation axis of the fifth reduction gear set 235 through an axial hole; a rotation axis of the assistant wheel 242 is positioned at the panels 221 through the fixing holes 222, and is rotatable in the fixing holes 222; the material feeding gear 241 and the assistant wheel 242 are both disposed on an outer side of the panels 221; the material feeding gear 241 and the assistant wheel 242 are disposed on the same outer side; a wire feeding gap is provided between the material feeding gear 241 and the assistant wheel 242; the wire feeding gap is smaller than or equal to a diameter of material fed to the 3D pen; the material guiding tube 243 is a hollow cylindrical soft tube; one end of the material guiding tube 243 is positioned below the wire feeding gap, another end of the material guiding tube 243 is positioned above the heating device 3.

The heating device 3 heats up and melts the material fed to the 3D pen; the heating device 3 is provided inside the head cover 11; the heating device 3 comprises a nozzle 31, a heating cavity 32 and a temperature sensor 33; an outer surface of the nozzle 31 is provided with a heat insulation layer 311; a center part of the nozzle 31 is provided with a through hole 312 for feeding out the material; the through hole 312 is in communication with the heating cavity 32; the temperature sensor 33 is provided on an outer wall of the heating cavity 32.

The heat dissipation device 4 is used for dissipating heat of various components of the 3D pen. The heat dissipation device 4 is provided inside shell body 12; the heat dissipation device 4 is positioned between the power supply slot 121 and the material feeding motor 21; the heat dissipation device 4 comprises a heat dissipation motor 41 and a heat dissipation fan 42 mounted on a rotation axis of the heat dissipation motor 41; hot air from a lower part inside the shell 1 is sucked up and discharged through the ventilation openings 132 to achieve good heat dissipation effect, such that various components will not be over heated and therefore damaged during operation. Accordingly, the service life of the 3D pen is lengthened.

The control chip is a RP-100A control chip; the material feeding motor 21, the heat dissipation motor 41, the heating cavity 32 and the temperature sensor 33 are all electrically connected with the control chip.

The control panel 5 is provided on an outer surface of the shell body 12; a wire feeding button 51, a speed adjustment button 52, a wire withdrawing button 53 and a display 54 are mounted on the control panel 5; the wire feeding button 51, the speed adjustment button 52, the wire withdrawing button 53 and the display 54 are all electrically connected with the control chip; the display 54 is a liquid crystal display or an LED display; the wire feeding button 51 controls rotation of the material feeding motor 21; material is fed by positive rotation of the material feeding gear 241 driven by the motion transmission mechanism 23; the speed adjustment button 52 controls rotation speed of the material feeding motor 21, so as to control rotation speed of the material feeding gear 241 and accordingly adjust the speed of feeding the material; the wire withdrawing button 53 controls reverse rotation of the material feeding motor 21; material is withdrawn by reverse rotation of the material feeding gear 241 driven by the motion transmission mechanism 23; the display 54 displays a temperature of the heating cavity 32 so as to achieve real time monitor and display of the temperature of the heating cavity 32.

During operation, connect the 3D pen to a power supply through a power adaptor; turn on the material feeding motor 21 so that the material feeding motor 21 rotates positively; positive rotation of the material feeding motor 21 is transmitted through the motion transmission mechanism 23 to drive the material feeding gear 241 to rotate positively; feed in material into the 3D pen through the material feeding opening 131; the material enters into the wire feeding gap between the material feeding gear 241 and the assistant wheel 242 because a diameter of the material is equal to or larger than the material feeding gap between the material feeding gear 241 and the assistant wheel 242; the material feeding gear 241 which is rotating will drive the assistant wheel to passively rotate in a reverse direction through the material. Accordingly longitudinal wire feeding from top to down along the shell 1 of the 3D pen is achieved. The material enters the heating cavity 32 through the material guiding tube 243; the heating cavity 32 heats and melts the material; and then the melted material flows out from the through hole 312 of the nozzle 31 for 3D drawing. When the 3D pen is not used, reverse the rotation of the material feeding motor 21; the reverse rotation of the material feeding motor 21 is transmitted by the motion transmission mechanism 23 to drive the material feeding gear 241 to rotate reversely, as such, the material is withdrawn from bottom to top. The temperature sensor 33 can monitor the temperature inside the heating cavity 32. When the temperature inside the heating cavity 32 has reached a predetermined level, the temperature sensor 33 transmits a signal to the control chip, and then the control chip will stop heating inside the heating cavity 32, so as to attain a controlled constant temperature.

The above description is only a preferred embodiment of the present invention. The present invention should not be limited to the embodiment described above. During actual implementation, partial and minor structural changes may be possible. Any changes or variations not deviated from the essence and scope of the present invention and which fall within the scope defined by the claims and within the same technical field of the present invention are intended to be covered by the present invention.

What is claimed is:

1. A 3D pen, comprising a shell, a material feeding device, a heating device and a control chip, wherein a material feeding opening is provided on the shell; the material feeding device comprises a material feeding motor, a motion transmission mechanism and a material feeding mechanism; the material feeding motor is longitudinally disposed along the shell; a single start worm is provided at a rotation axis of the material feeding motor; the single start worm is connected with the motion transmission mechanism; the material feeding mechanism comprises a material feeding gear and an assistant wheel; the motion transmission mechanism is connected with the material feeding gear; a wire feeding gap is provided between the material feeding gear and the assistant wheel; the heating device comprises a nozzle and a heating cavity; the material feeding motor and the heating cavity are both electrically connected with the control chip.

2. The 3D pen as in claim 1, wherein the shell comprises a head cover, a shell body and a tail cover; the head cover has a conical shape which are opened at two ends; a surface of the head cover is provided with rows of arc-shaped heat dissipation holes; the shell body is a hollow cylinder; a mouth of a top part of the shell body is provided with a power supply slot; the 3D pen is supplied with power by connecting the power supply slot with a power supply through a power adapter; a top surface of the tail cover is provided with the material feeding opening; ventilation openings are also provided on the top surface of the tail cover.

3. The 3D pen as in claim 1, wherein the motion transmission mechanism comprises a first reduction gear set, a second reduction gear set, a third reduction gear set, a fourth reduction gear set and a fifth reduction gear set; the single start worm meshes with a larger gear wheel of the first reduction gear set; a smaller gear wheel of the first reduction gear set meshes with a larger gear wheel of the second reduction gear set; a smaller gear wheel of the second reduction gear set meshes with a larger gear wheel of the third reduction gear set; a smaller gear wheel of the third reduction gear set meshes with a larger gear wheel of the fourth reduction gear set; a smaller gear wheel of the fourth reduction gear set meshes with a larger gear wheel of the fifth reduction gear set.

4. The 3D pen as in claim 3, wherein the material feeding device also comprises a fixing mechanism; the fixing mechanism comprises two longitudinally disposed direction fixing panels; the two panels are parallel with each other; fixing holes are provided on the panels for fixing the motion transmission mechanism and the material feeding mechanism.

5. The 3D pen as in claim 4, wherein rotation axes of the first reduction gear set, second reduction gear set, third reduction gear set, fourth reduction gear set and the fifth reduction gear set are positioned between the two panels through the fixing holes, and are rotatable at the fixing holes.

6. The 3D pen as in claim 5, wherein the material feeding gear is fixed to the rotation axis of the fifth reduction gear set through an axial hole; a rotation axis of the assistant wheel is positioned at the panels through the fixing holes, and is rotatable in the fixing holes; the material feeding gear and the assistant wheel are both disposed on an outer side of the panels; the material feeding gear and the assistant wheel are disposed on the same outer side.

7. The 3D pen as in claim 1, wherein the material feeding mechanism also comprises a material guiding tube; the material guiding tube is a hollow cylindrical soft tube; one end of the material guiding tube is positioned below the wire feeding gap, another end of the material guiding tube is positioned above the heating device.

8. The 3D pen as in claim 2, wherein the 3D pen also comprises a heat dissipation device; the heat dissipation device is positioned between the power supply slot and the material feeding motor; the heat dissipation device comprises a heat dissipation motor and a heat dissipation fan mounted on a rotation axis of the heat dissipation motor.

9. The 3D pen as in claim 1, wherein the heating device also comprises a temperature sensor; the temperature sensor is provided on an outer wall of the heating cavity; the temperature sensor and the control chip are electrically connected.

10. The 3D pen as in claim 9, wherein the 3D pen also comprises a control panel; the control panel is provided on an outer surface of the shell; a wire feeding button, a speed adjustment button, a wire withdrawing button and a display are mounted on the control panel; the wire feeding button, the speed adjustment button, the wire withdrawing button and the display are all electrically connected with the control chip.
